(19) United States
(12) Patent Application Publication
(10) Pub. No.: US 2024/0079701 A1
(43) Pub. Date: Mar. 7, 2024

(54) ELECTRICALLY-DRIVEN POWER UNIT OF COMPACT BATTERY PACK AND WORKING MACHINE

(71) Applicant: Chongqing Tuosi Electric Power Technology Co., Ltd., Chongqing (CN)

(72) Inventor: Chenglin Jiang, Chongqing (CN)

(21) Appl. No.: 18/231,597

(22) Filed: Aug. 8, 2023

(30) Foreign Application Priority Data
Sep. 2, 2022 (CN) 202211071749.6

(51) Int. Cl. H01M 50/213; H01M 50/242; H01M 50/244; H01M 50/264

(52) U.S. Cl. CPC H01M 50/213; H01M 50/242; H01M 50/244; H01M 50/264

(57) ABSTRACT

The present invention discloses an electrically-driven power unit of a compact battery pack, which comprises a motor and a battery pack, wherein the motor is mounted on a base, the battery pack is supported on an upper part of the motor through a supporting frame, the supporting frame is shaped around the periphery of the motor, an arch-shaped supporting portion matched with the upper part of the motor is formed on an upper part of the supporting frame, a concave portion matched with the arch-shaped supporting portion is arranged at a bottom of the battery pack, and the arch-shaped supporting portion of the supporting frame is supported in the concave portion of the battery pack. The present invention can reduce the overall height of the electrically-driven power unit on the premise of not reducing the endurance of the battery pack so as to satisfy the overall mounting size limitation.

### FIELD OF THE INVENTION

The present invention relates to the technical field of general power, and in particular to an electrically-driven power unit of a compact battery pack and a working machine.

### BACKGROUND OF THE INVENTION

With the intensive study of environmental issues, more power units are being driven by electric power instead of fuel.

The specification of the Chinese invention patent CN112602255A discloses an electric power unit, which comprises a motor and a battery pack for supplying power to the motor, wherein the electric power unit can be mounted on various working machines in place of a fuel engine and achieves miniaturization and versatility of the electric power unit to some extent.

As can be seen from the specification of the above patent and FIG. 5A, the battery pack in the patent is shaped as a cuboid and is mounted at the top of the motor through a frame. In practical application, the height of the electric power unit is higher than that of the common fuel engine on the market due to the shape of the battery pack. Therefore, how to reduce the overall height of the battery pack and meanwhile ensure the endurance of the battery pack under the condition of satisfying the overall size limitation of the fuel engine is a problem to be overcome in a case that the electric power unit replaces the fuel engine.

### SUMMARY OF THE INVENTION

Aiming at the defects in the prior art, the present invention provides an electrically-driven power unit of a compact battery pack and a working machine, so that the overall height of the electrically-driven power unit is reduced on the premise of not reducing the endurance of the battery pack so as to satisfy the overall mounting size limitation.

In an aspect, the present invention provides an electrically-driven power unit of a compact battery pack, which comprises a motor and a battery pack, wherein the motor is mounted on a base, the battery pack is supported on an upper part of the motor through a supporting frame, the supporting frame is shaped around the periphery of the motor, an arch-shaped supporting portion matched with the upper part of the motor is formed on an upper part of the supporting frame, a concave portion matched with the arch-shaped supporting portion is arranged at a bottom of the battery pack, and the arch-shaped supporting portion of the supporting frame is supported in the concave portion of the battery pack.

Furthermore, a first mounting portion and a second mounting portion are respectively arranged on both sides of the arch-shaped supporting portion on the supporting frame, and areas of the bottom of the battery pack located on both sides of the concave portion are respectively supported on the first mounting portion and the second mounting portion.

Furthermore, cushion pads are arranged between the bottom of the battery pack and the arch-shaped supporting portion, the first mounting portion and the second mounting portion on the supporting frame.

Furthermore, a side part of the first mounting portion is vertically aligned with a side part on a same side of the supporting frame, and the second mounting portion is of a cantilever structure formed by extending the side part of the supporting frame outwards.

Furthermore, the battery pack comprises a box body and a battery set and a battery management system arranged in the box body, wherein an upper inclination angle of the box body on one side of the second mounting portion is set as a mounting space for the battery management system, and a rest part in the box body is set as a mounting space for the battery set.

Furthermore, supports are arranged on both sides of the motor on the base, lower parts of both sides of the supporting frame are respectively mounted on the supports on the corresponding sides through elastic vibration damping bodies, and the elastic vibration damping bodies on both sides are obliquely arranged, such that axes of the elastic vibration damping bodies on both sides intersect above;

a center of gravity of the battery pack is located in a lower area where the axes of the elastic vibration damping bodies on both sides intersect.

Furthermore, the battery set is supported in the box body through vibration damping blocks.

Furthermore, the battery set comprises a battery cell holder and a plurality of cylindrical battery cells longitudinally distributed on the battery cell holder in parallel, the cylindrical battery cells being distributed in a regular triangle shape.

Furthermore, an output shaft of the motor is in a horizontal or vertical direction.

In another aspect, the present invention provides a working machine, which comprises the electrically-driven power unit of a compact battery pack described above.

The beneficial effects of the present invention are as follows:

The supporting frame of the present application is shaped around the periphery of the motor to form an arch-shaped supporting portion fitting on the upper part of the motor. Simultaneously, through the arrangement of the concave portion at the bottom of the battery pack, the battery pack is no longer a simple cuboid, but is designed into a special molding of fitting the arch-shaped supporting portion of the supporting frame, making full use of the space of the side part of the motor, and thus realizing the effective utilization in space. The battery pack structure is more compact, and the overall height of the electrically-driven power unit can be reduced on the premise of not reducing the endurance of the battery pack, so as to satisfy the overall mounting size limitation, which is beneficial to realizing the miniaturization of the electrically-driven power unit and further replacing the fuel engine.

### BRIEF DESCRIPTION OF THE DRAWINGS

In order to more clearly illustrate the technical schemes in the embodiments of the present invention or in the prior art, the drawings required to be used in the description of the embodiments or the prior art are briefly introduced below. In all of the drawings, like elements or parts are generally identified by like reference numerals. In the drawings, elements or parts are not necessarily drawn to actual scale.

FIG. 1 is a schematic structural diagram in a case that an output shaft of a motor is in a horizontal direction according to an embodiment of the present invention;

FIG. 2 is a schematic block diagram of a battery pack according to an embodiment of the present invention;

FIG. 3 is an exploded diagram of a battery pack according to an embodiment of the present invention;

FIG. 4 is a sectional view of the interior of a battery pack according to an embodiment of the present invention;

FIG. 5 is a schematic diagram of a position of a center of gravity of a battery pack according to an embodiment of the present invention; and

FIG. 6 is a schematic structural diagram in a case that an output shaft of a motor is in a vertical direction according to another embodiment of the present invention.

In the figures, 100 is motor; 200 is supporting frame; 210 is arch-shaped supporting portion; 220 is first mounting portion; 230 is second mounting portion; 240 is cushion pad; 300 is battery pack; 310 is concave portion; 320 is box body; 321 is lower box body; 322 is upper box body; 323 is vibration damping block; 330 is battery set; 331 is battery cell holder; 332 is cylindrical battery cell; 340-is battery management system; 350 is center of gravity; 400 is base; 410 is support; 420 is elastic vibration damping body.

### DETAILED DESCRIPTION OF THE INVENTION

Examples of the technical schemes of the present invention will be described in detail below with reference to the accompanying drawings. The following examples are only for illustrating the technical schemes of the present invention more clearly, and therefore are only used as examples and cannot be used to limit the protection scope of the present invention.

It should be noted that the terms or words used in the present application should not be construed as being limited to general or dictionary meanings unless otherwise specified, but interpreted only as meanings and concepts conforming to the technical idea of the present invention on the basis of the principle that “the inventor appropriately defines the concept of the terms in order to describe his own invention in the best way”.

### Embodiment 1

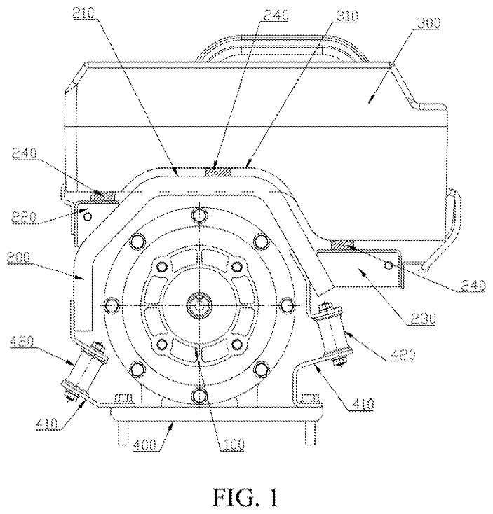

As shown in FIGS. 1-5, Embodiment 1 provides an electrically-driven power unit of a compact battery pack, which comprises a motor 100 and a battery pack 300, wherein

the motor 100 is mounted on a base 400, an output shaft of the motor 100 is in a horizontal direction in this embodiment, and the base 400 may also be an object to be carried by the electrically-driven power unit.

The battery pack 300 is supported on an upper part of the motor 100 through a supporting frame 200, the supporting frame 200 is shaped around the periphery of the motor 100, an arch-shaped supporting portion 210 matched with the upper part of the motor 100 is formed on an upper part of the supporting frame 200, a concave portion 310 matched with the arch-shaped supporting portion 210 is arranged at a bottom of the battery pack 300, and the arch-shaped supporting portion 210 of the supporting frame 200 is supported in the concave portion 310 of the battery pack 300.

The supporting frame 200 of the present application is shaped around the periphery of the motor 100 to form an arch-shaped supporting portion 210 fitting on the upper part of the motor 100. Simultaneously, through the arrangement of the concave portion 310 at the bottom of the battery pack 300, the battery pack 300 is no longer a simple cuboid, but is designed into a special molding of fitting the arch-shaped supporting portion 210 of the supporting frame 200, making full use of the space of the side part of the motor 100, and thus realizing the effective utilization in space. The battery pack structure is more compact, the overall height of the electrically-driven power unit can be reduced on the premise of not reducing the endurance of the battery pack 300, which is beneficial to realizing the miniaturization of the electrically-driven power unit and further replacing the fuel engine.

In this embodiment, referring to FIG. 1, a first mounting portion 220 and a second mounting portion 230 are respectively arranged on both sides of the arch-shaped supporting portion 210 on the supporting frame 200, and areas of the bottom of the battery pack 300 located on both sides of the concave portion 310 are respectively supported on the first mounting portion 220 and the second mounting portion 230, such that the battery pack 300 can be more stably supported on the supporting frame 200.

In this embodiment, the battery pack 300 is directly mounted on the supporting frame 200, and in order to form the cushioning between the supporting frame 200 and the battery pack 300, cushion pads 240 are arranged between the bottom of the battery pack 300 and the arch-shaped supporting portion 210, the first mounting portion 220 and the second mounting portion 230 on the supporting frame 200, and the cushion pads 240 can further damp vibration of the battery pack 300 during operation; preferably, the cushion pads 240 in this embodiment are fixed at the bottom of the battery pack 300. If the battery pack 300 falls, the cushion pads 240 at the bottom of the battery pack will contact the ground before the battery pack 300, so as to play a role of buffer protection.

In this embodiment, a side part of the first mounting portion 220 is vertically aligned with a side part on a same side of the supporting frame 200, and the second mounting portion 230 is of a cantilever structure formed by extending the side part of the supporting frame 200 outwards. When the battery pack 300 is mounted on the supporting frame 200, the side part of the battery pack 300 supported on the first mounting portion 220 is substantially aligned with the side part of the supporting frame 200, and the side part of the battery pack 300 supported on the second mounting portion 230 extends out of the side part of the supporting frame 200, without any mechanism arranged on the lower side of the second mounting portion 230.

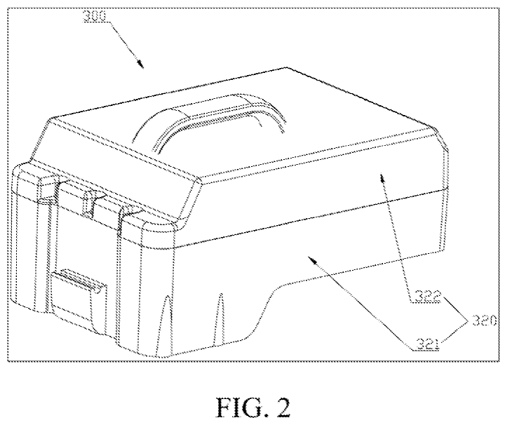

In this embodiment, referring to FIGS. 2, 3, and 4, the battery pack 300 comprises a box body 320, and a battery set 330 and a battery management system 340 arranged in the box body 320, wherein an upper inclination angle of the box body 320 on one side of the second mounting portion 230 is set as a mounting space for the battery management system 340, and a rest part of the box body 320 is set as a mounting space for the battery set 330.

In this embodiment, one side end of the battery pack 300 is supported on the first mounting portion 220 and is substantially aligned with the side part of the supporting frame 200, the other side end of the battery pack 300 is supported on the second mounting portion 230 and extends out of the side part of the supporting frame 200, and the center of gravity 350 of the battery pack 300 makes an offset toward the side extending out of the supporting frame 200. However, the closer the center of gravity 350 of the battery pack 300 is to the center of the motor 100, the better the overall stability of the combination of the battery pack 300 and the motor 100. Since the per unit weight of a battery set 330 is much greater than that of the battery management system 340, in the present application, through the arrangement of the battery management system 340 on an upper inclination angle of the box body 320 on one side of the second mounting portion 230, and filling the rest part of the box body 320 with the battery set 330, the center of gravity 350 of the battery pack 300 can be close to one side of the center of the motor 100 as far as possible, and meanwhile the space can be made full use of.

Referring to FIG. 5, in this embodiment, supports 410 are arranged on both sides of the motor 100 on the base 400, lower parts of both sides of the supporting frame 200 are respectively mounted on the supports 410 on the corresponding sides through elastic vibration damping bodies 420, and the elastic vibration damping bodies 420 on both sides are obliquely arranged, such that axes of the elastic vibration damping bodies 420 on both sides intersect above. The center of gravity 350 of the battery pack 300 is located in a lower area where the axes of the elastic vibration damping bodies 420 on both sides intersect.

In the present application, the battery pack 300 is designed according to the above scheme, such that the center of gravity 350 of the battery pack 300 is centered as much as possible, and then the inclination angles of the elastic vibration damping bodies 420 on both sides of the supporting frame 200 are designed, such that the center of gravity 350 of the battery pack 300 is located in the lower area where the axes of the elastic vibration damping bodies 420 on both sides intersect. Through the control of the center of gravity 350 of the battery pack 300 to be located in the lower area where the axes of the elastic vibration damping bodies 420 on both sides intersect, the battery pack 300 is stably supported, and a good vibration damping effect is also provided for the battery pack 300, and the use requirements of the working machine with large vibration can be satisfied.

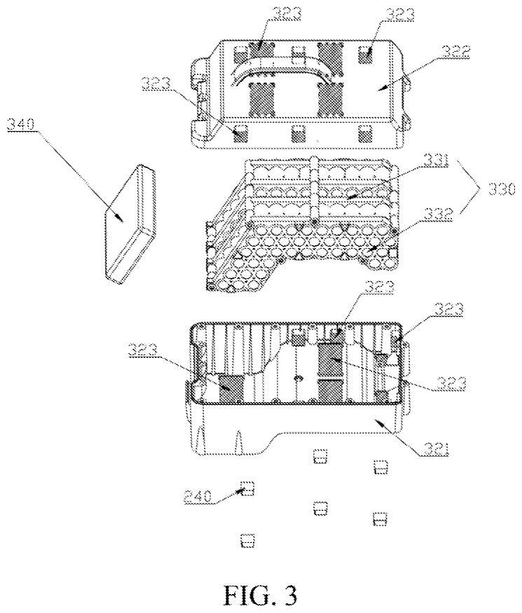

In this embodiment, referring to FIG. 3, the battery set 330 is supported in the box body 320 through vibration damping block 323. Specifically, the box body 320 in this embodiment comprises a lower box body 321 and an upper box body 322, wherein vibration damping blocks 323 are arranged at the bottom and the periphery of the lower box body 321, and at the top and the periphery of the upper box body 322, and the vibration damping blocks 323 can play a role of vibration damping and buffering on the battery set 330 in the box body 320.

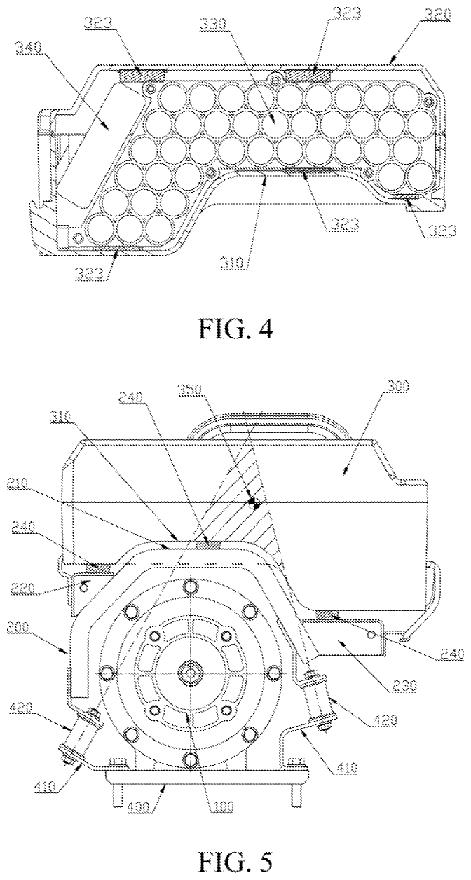

In this embodiment, referring to FIGS. 3 and 4, the battery set 330 comprises a battery cell holder 331 and a plurality of cylindrical battery cells 332 longitudinally distributed on the battery cell holder 331 in parallel. The battery set 330 adopts a cylindrical battery cell structure which is convenient to form a unique molding of the battery pack 300, and then it is easy to realize the surrounding design of the battery pack 300 on the periphery of the motor 100. The cylindrical battery cells 332 distributed in a mode of arranging in the same direction as the output direction have the advantages of lower center of gravity, better vibration absorption performance and more stable overall structure compared with those distributed in a vertical arrangement mode.

For reference, the cylindrical battery cells 332 are distributed in a regular triangle shape, so as to improve the arrangement efficiency of the cylindrical battery cells 332.

### Embodiment 2

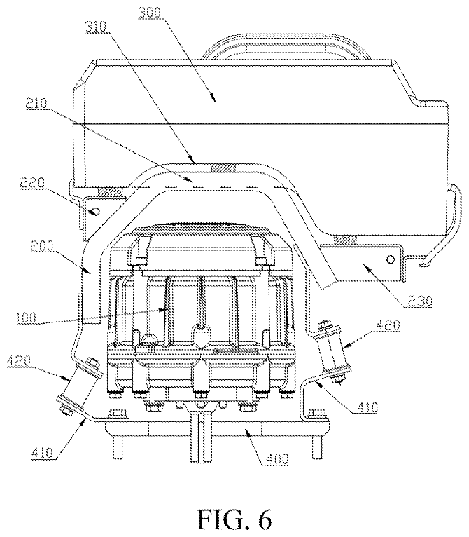

As shown in FIG. 6, Embodiment 2 provides an electrically-driven power unit of a compact battery pack; Embodiment 2 is different from Embodiment 1 in that the output shaft of the motor 100 in Embodiment 2 is in a vertical direction.

The direction of the output shaft of the motor 100 of the power unit is divided into a horizontal direction and a vertical direction, and the present invention can simultaneously satisfy the requirements of adapting to the two output directions due to its universality.

The battery pack 300 is specially shaped with a concave bottom, so that the battery pack 300 and the motor 100 can be assembled and combined with good space efficiency even when the output shaft of the motor 100 is in a vertical direction.

Here, the working machine having vertical output requirements can be mounted properly only by individually setting the supporting frame 200.

In a case that the output shaft of the motor 100 is in the horizontal direction, the motor 100 and the battery pack 300 are designed in a general manner, and in this embodiment, various types of working machines can be mounted properly only by specially setting the supporting frame 200 and the appearance shell.

### Embodiment 3

The present invention provides a working machine, which comprises the electrically-driven power unit of a compact battery pack described above and includes a construction machine, an agricultural machine, a garden machine and the like, such as a flat plate tamper, a cement grinder, a mini-tiller and a mower.

Finally, it should be noted that, the above embodiments are only for illustrating the technical schemes of the present invention, and not to limit the same; while the present invention has been described in detail with reference to the foregoing embodiments, it will be understood by those skilled in the art that, the technical schemes described in the foregoing embodiments may still be modified, or some or all of the technical features may be equivalently substituted; such modifications and substitutions do not depart from the spirit and scope of the embodiments of the present invention, and shall fall within the scope of the claims and the specification of the present invention.

1. An electrically-driven power unit of a compact battery pack, comprising
a motor and a battery pack;
wherein the motor is mounted on a base;
the battery pack is supported on an upper part of the motor through a supporting frame;
the supporting frame is shaped around a periphery of the motor;
an arch-shaped supporting portion matched with the upper part of the motor is formed on an upper part of the supporting frame;
a concave portion matched with the arch-shaped supporting portion is arranged at a bottom of the battery pack; and
the arch-shaped supporting portion of the supporting frame is supported in the concave portion of the battery pack.

2. The electrically-driven power unit of a compact battery pack according to claim 1, wherein a first mounting portion and a second mounting portion are respectively arranged on both sides of the arch-shaped supporting portion on the supporting frame, and areas of the bottom of the battery pack located on both sides of the concave portion are respectively supported on the first mounting portion and the second mounting portion.

3. The electrically-driven power unit of a compact battery pack according to claim 2, wherein cushion pads are arranged between the bottom of the battery pack and the arch-shaped supporting portion, the first mounting portion and the second mounting portion on the supporting frame.

4. The electrically-driven power unit of a compact battery pack according to claim 2, wherein
a side part of the first mounting portion is vertically aligned with a side part on a same side of the supporting frame, and the second mounting portion is of a cantilever structure formed by extending the side part of the supporting frame outwards.

5. The electrically-driven power unit of a compact battery pack according to claim 2, wherein the battery pack comprises a box body and a battery set and a battery management system arranged in the box body, wherein an upper inclination angle of the box body on one side of the second mounting portion is set as a mounting space for the battery management system, and a rest part in the box body is set as a mounting space for the battery set.

6. The electrically-driven power unit of a compact battery pack according to claim 1, wherein supports are arranged on both sides of the motor on the base, lower parts of both sides of the supporting frame are respectively mounted on the supports on the corresponding sides through elastic vibration damping bodies, and the elastic vibration damping bodies on both sides are obliquely arranged, such that axes of the elastic vibration damping bodies on both sides intersect above; and
a center of gravity of the battery pack is located in a lower area where the axes of the elastic vibration damping bodies on both sides intersect.

7. The electrically-driven power unit of a compact battery pack according to claim 5, wherein the battery set is supported in the box body through vibration damping blocks.

8. The electrically-driven power unit of a compact battery pack according to claim 5, wherein the battery set comprises a battery cell holder and a plurality of cylindrical battery cells longitudinally distributed on the battery cell holder in parallel, the cylindrical battery cells being distributed in a regular triangle shape.

9. The electrically-driven power unit of a compact battery pack according to claim 1, wherein an output shaft of the motor is in a horizontal or vertical direction.

10. A working machine, comprising the electrically-driven power unit of a compact battery pack according to claim 1.
